(19) United States
(12) Patent Application Publication
(10) Pub. No.: US 2024/0158600 A1
(43) Pub. Date: May 16, 2024

(54) BIODEGRADABLE CELLULOSE ACETATE FOAMS

(71) Applicant: Eastman Chemical Company, Kingsport, TN (US)

(72) Inventor: Guarav Amarpuri

(73) Assignee: Eastman Chemical Company, Kingsport, TN (US)

(21) Appl. No.: 18/570,186

(22) PCT Filed: Jun. 16, 2022
(86) PCT No.: PCT/US2022/033762

§ 371 Date: Dec. 14, 2023

Related U.S. Application Data
(60) Provisional application No. 63/202,649, filed on Jun. 18, 2021.

(51) Int. Cl. C08J 9/228; C08J 9/00; C08J 9/12; C08J 9/14

(52) U.S. Cl. CPC C08J 9/228; C08J 9/0023; C08J 9/122; C08J 9/141; C08J 2205/04; C08J 2301/12

(57) ABSTRACT

The present application discloses biodegradable cellulose acetate foam, wherein the foam has a density of from 0.01 to 0.9 g/cm³, an average foam cell size between 0.05 mm to 1.0 mm, and wherein the Rrms surface area roughness is from 0.01 to 500 microns. The present application also discloses compositions that can be used to prepare the foam.

### BACKGROUND OF THE INVENTION

Foamed materials are useful in applications such as in insulating, food and nonfood packaging, and sound proofing. One such commercially important material used to make foams is polystyrene. However, polystyrene is not biodegradable. Moreover, some states are starting to ban polystyrene based foams.

Cellulose acetate based foams can be biodegradable and can be used as a replacement for polystyrene foams. However, there is a need for cellulose acetate based foams that have sufficiently low densities, with good thermal and mechanical properties that can be processed on commercial extrusion equipment and that can be thermoformed on commercial thermoforming equipment.

### SUMMARY OF THE INVENTION

The present application discloses a biodegradable cellulose acetate foam, wherein the foam has a density of from 0.01 to 0.9 g/cm³, an average foam cell size between 0.05 mm to 1.0 mm, and wherein the Rᵣₘₛ surface area roughness is from 0.01 to 500 microns.

The present application also discloses a foamable composition comprising:
(1) a cellulose acetate having a degree of substitution of acetyl (DS_{Ac}) in the range of from 2.2 to 2.6;
(2) 5 to 30 wt % of a plasticizer;
(3) 0.1 to 3.0 wt % of a physical nucleating agent;
(4) 0.1 to 4.5 wt % of a first physical blowing agent; and
(5) 0.1 to 3.0 wt % of a second physical blowing agent chosen from ((C₁₋₃)alkyl)₂O, CO₂, N₂, (C₃₋₇)ketones, (C₁₋₆)alkanol, (C₄₋₆)alkene, or combinations thereof.
wherein the proportions of each component of the composition is based on the total weight of the composition.

The biodegradable cellulose acetate foam or composition can be formed into articles.

### DETAILED DESCRIPTION OF THE INVENTION

### Definitions

It should be understood that the following is not intended to be an exclusive list of defined terms. Other definitions may be provided in the foregoing description, such as, for example, when accompanying the use of a defined term in context.

As used herein, the terms “a,” “an,” and “the” mean one or more.

As used herein, the terms “comprising,” “comprises,” and “comprise” are open-ended transition terms used to transition from a subject recited before the term to one or more elements recited after the term, where the element or elements listed after the transition term are not necessarily the only elements that make up the subject.

Nucleating agent means a chemical or physical material that provides sites for cells to form in a molten formulation mixture. Nucleating agents may include chemical nucleating agents and physical nucleating agents. The nucleating agent may be blended with the formulation that is introduced into the hopper of the extruder. Alternatively, the nucleating agent may be added to the molten resin mixture in the extruder.

Suitable physical nucleating agents have desirable particle size, aspect ratio, and top-cut properties. Examples include, but are not limited to, talc, CaCO₃, mica, and mixtures of at least two of the foregoing. One representative example is Heritage Plastics HT6000 Linear Low Density Polyethylene (LLDPE) Based Talc Concentrate.

Suitable chemical nucleating agents decompose to create cells in the molten formulation when a chemical reaction temperature is reached. These small cells act as nucleation sites for larger cell growth from a physical or other type of blowing agent. In one example, the chemical nucleating agent is citric acid or a citric acid-based material. One representative example is HYDROCEROL™ CF-40E (available from Clariant Corporation), which contains citric acid and a crystal nucleating agent.

A blowing agent refers to a physical or a chemical material (or combination of materials) that acts to expand nucleation sites. Blowing agents may include chemical blowing agents, physical blowing agents, combinations thereof, or several types of chemical and physical blowing agents. The blowing agent acts to reduce density by forming cells in the molten formulation at the nucleation sites. The blowing agent may be added to the molten resin mixture in the extruder.

Chemical blowing agents are materials that degrade or react to produce a gas. Chemical blowing agents may be endothermic or exothermic. Chemical blowing agents typically degrade at a certain temperature to decompose and release gas. Examples of chemical blowing agents include citric acid, sodium bicarbonate, sodium carbonate, ammonium bicarbonate, ammonium carbonate, and the like.

Examples of physical blowing agents include N₂, CO₂, alkanes, alkenes, ethers, ketones, argon, helium, air or mixtures.

“Rᵣₘₛ Surface Roughness” refers to the root mean squared roughness of a surface, which measures the vertical deviations of a real surface from its ideal form. The roughness refers to surface micro-roughness which may be different than measurements of large scale surface variations. Rᵣₘₛ surface roughness can be determined by using light profilometry.

In embodiments, the cellulose acetate utilized in this invention can be any that is known in the art and that is biodegradable. Cellulose acetate that can be used for the present invention generally comprise repeating units of the structure:

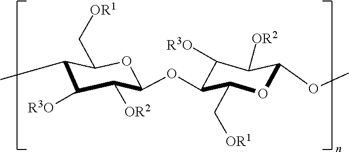

wherein R¹, R², and R³ are selected independently from the group consisting of hydrogen or acetyl. For cellulose esters, the substitution level is usually express in terms of degree of substitution (DS), which is the average number of non-OH substituents per anhydroglucose unit (AGU). Generally, conventional cellulose contains three hydroxyl groups in each AGU unit that can be substituted; therefore. DS can have a value between zero and three. Native cellulose is a large polysaccharide with a degree of polymerization from 250-5,000 even after pulping and purification, and thus the assumption that the maximum DS is 3.0 is approximately correct. Because DS is a statistical mean value, a value of 1 does not assure that every AGU has a single substitutent. In some cases, there can be unsubstituted anhydroglucose units, some with two and some with three substitutents, and typically the value will be a non-integer. Total DS is defined as the average number of all of substituents per anhydroglucose unit. The degree of substitution per AGU can also refer to a particular substitutent, such as, for example, hydroxyl or acetyl. In embodiments, n is an integer in a range from 25 to 250, or 25 to 200, or 25 to 150, or 25 to 100, or 25 to 75.

In embodiments of the invention, the cellulose acetates have at least 2 anhydroglucose rings and can have between at least 50 and up to 5,000 anhydroglucose rings, or at least 50 and less than 150 anhydroglucose rings. The number of anhydroglucose units per molecule is defined as the degree of polymerization (DP) of the cellulose acetate. In embodiments, cellulose esters can have an inherent viscosity (IV) of about 0.2 to about 3.0 deciliters/gram, or about 0.5 to about 1.8, or about 1 to about 1.5, as measured at a temperature of 25° C. for a 0.25 gram sample in 100 ml of a 60/40 by weight solution of phenol/tetrachloroethane. In embodiments, cellulose acetates useful herein can have a DS/AGU of about 1 to about 2.5, or 1 to less than 2.2, or 1 to less than 1.5, and the substituting ester is acetyl.

Cellulose acetates can be produced by any method known in the art. Examples of processes for producing cellulose esters are taught in Kirk-Othmer, Encyclopedia of Chemical Technology, 5th Edition, Vol. 5, Wiley-Interscience, New York (2004), pp. 394-444. Cellulose, the starting material for producing cellulose acetates, can be obtained in different grades and sources such as from cotton linters, softwood pulp, hardwood pulp, corn fiber and other agricultural sources, and bacterial cellulose, among others.

One method of producing cellulose acetates is esterification of the cellulose by mixing cellulose with the appropriate organic acids, acid anhydrides, and catalysts. Cellulose is then converted to a cellulose triester. Ester hydrolysis is then performed by adding a water-acid mixture to the cellulose triester, which can then be filtered to remove any gel particles or fibers. Water is then added to the mixture to precipitate the cellulose ester. The cellulose ester can then be washed with water to remove reaction by-products followed by dewatering and drying.

The cellulose triesters to be hydrolyzed can have three acetyl substitutents. These cellulose esters can be prepared by a number of methods known to those skilled in the art. For example, cellulose esters can be prepared by heterogeneous acylation of cellulose in a mixture of carboxylic acid and anhydride in the presence of a catalyst such as H2SO4. Cellulose triesters can also be prepared by the homogeneous acylation of cellulose dissolved in an appropriate solvent such as LiCl/DMAc or LiCl/NMP.

Those skilled in the art will understand that the commercial term of cellulose triesters also encompasses cellulose esters that are not completely substituted with acyl groups. For example, cellulose triacetate commercially available from Eastman Chemical Company, Kingsport, TN, U.S.A., typically has a DS from about 2.85 to about 2.99.

After esterification of the cellulose to the triester, part of the acyl substitutents can be removed by hydrolysis or by alcoholysis to give a secondary cellulose ester. As noted previously, depending on the particular method employed, the distribution of the acyl substituents can be random or non-random. Secondary cellulose esters can also be prepared directly with no hydrolysis by using a limiting amount of acylating reagent. This process is particularly useful when the reaction is conducted in a solvent that will dissolve cellulose. All of these methods yield cellulose esters that are useful in this invention.

In one embodiment or in combination with any of the mentioned embodiments, or in combination with any of the mentioned embodiments, the cellulose acetates are cellulose diacetates that have a polystyrene equivalent number average molecular weight (Mn) from about 10,000 to about 100,000 as measured by gel permeation chromatography (GPC) using NMP as solvent and polystyrene equivalent Mn according to ASTM D6474. In embodiments, the cellulose acetate composition comprises cellulose diacetate having a polystyrene equivalent number average molecular weights (Mn) from 10,000 to 90,000; or 10,000 to 80,000; or 10,000 to 70,000; or 10,000 to 60,000; or 10,000 to less than 60,000; or 10,000 to less than 55,000; or 10,000 to 50,000; or 10,000 to less than 50,000; or 10,000 to less than 45,000; or 10,000 to 40,000; or 10,000 to 30,000; or 20,000 to less than 60,000; or 20,000 to less than 55,000; or 20,000 to 50,000; or 20,000 to less than 50,000; or 20,000 to less than 45,000; or 20,000 to 40,000; or 20,000 to 35,000; or 20,000 to 30,000; or 30,000 to less than 60,000; or 30,000 to less than 55,000; or 30,000 to 50,000; or 30,000 to less than 50,000; or 30,000 to less than 45,000; or 30,000 to 40,000; or 30,000 to 35,000; as measured by gel permeation chromatography (GPC) using NMP as solvent and according to ASTM D6474.

The most common commercial secondary cellulose esters are prepared by initial acid catalyzed heterogeneous acylation of cellulose to form the cellulose triester. After a homogeneous solution in the corresponding carboxylic acid of the cellulose triester is obtained, the cellulose triester is then subjected to hydrolysis until the desired degree of substitution is obtained. After isolation, a random secondary cellulose ester is obtained. That is, the relative degree of substitution (RDS) at each hydroxyl is roughly equal.

The cellulose acetates useful in the present invention can be prepared using techniques known in the art, and can be chosen from various types of cellulose esters, such as for example the cellulose esters that can be obtained from Eastman Chemical Company, Kingsport, TN, U.S.A., e.g., Eastman™ Cellulose Acetate CA 398-30 and Eastman™ Cellulose Acetate CA 398-10.

In embodiments of the invention, the cellulose acetate can be prepared by converting cellulose to a cellulose ester with reactants that are obtained from recycled materials, e.g., a recycled plastic content syngas source. In embodiments, such reactants can be cellulose reactants that include organic acids and/or acid anhydrides used in the esterification or acylation reactions of the cellulose, e.g., as discussed herein.

In one embodiment or in combination with any of the mentioned embodiments, or in combination with any of the mentioned embodiments, of the invention, a cellulose acetate composition comprising at least one recycle cellulose acetate is provided, wherein the cellulose acetate has at least one substituent on an anhydroglucose unit (AU) derived from recycled content material, e.g., recycled plastic content syngas.

The present application discloses a biodegradable cellulose acetate foam, wherein the foam has a density of from 0.01 to 0.9 g/cm³, an average foam cell size between 0.05 mm to 1.0 mm, and wherein the Rᵣₘₛ surface area roughness is from 0.01 to 500 microns.

In one embodiment or in combination with any of the embodiments mentioned herein, the foam has a density of from 0.01 to 0.8 g/cm³, or 0.01 to 0.7 g/cm³, or 0.01 to 0.6 g/cm³, or 0.01 to 0.5 g/cm³, or 0.01 to 0.4 g/cm³, or 0.01 to 0.3 g/cm³, or 0.01 to 0.2 g/cm³, or 0.01 to 0.1 g/cm³, 0.01 to 0.08 g/cm³, or 0.04 to 0.8 g/cm³, or 0.04 to 0.7 g/cm³, or 0.04 to 0.6 g/cm³, or 0.04 to 0.5 g/cm³, or 0.04 to 0.4 g/cm³, or 0.04 to 0.3 g/cm³, or 0.04 to 0.2 g/cm³, or 0.04 to 0.1 g/cm³, or 0.06 to 0.8 g/cm³, or 0.06 to 0.7 g/cm³, or 0.06 to 0.6 g/cm³, or 0.06 to 0.5 g/cm³, or 0.06 to 0.4 g/cm³, or 0.06 to 0.3 g/cm³, or 0.06 to 0.2 g/cm³, or 0.06 to 0.1 g/cm³, or 0.08 to 0.8 g/cm³, or 0.08 to 0.7 g/cm³, or 0.08 to 0.6 g/cm³, or 0.08 to 0.5 g/cm³, or 0.08 to 0.4 g/cm³, or 0.08 to 0.3 g/cm³, or 0.08 to 0.2 g/cm³, or 0.08 to 0.1 g/cm³, or 0.1 to 0.8 g/cm³, or 0.1 to 0.7 g/cm³, or 0.1 to 0.6 g/cm³, or 0.1 to 0.5 g/cm³, or 0.1 to 0.4 g/cm³, or 0.1 to 0.3 g/cm³, or 0.1 to 0.2 g/cm³, or 0.2 to 0.8 g/cm³, or 0.2 to 0.8 g/cm³, or 0.2 to 0.7 g/cm³, or 0.2 to 0.6 g/cm³, or 0.2 to 0.5 g/cm³, or 0.2 to 0.4 g/cm³, or 0.2 to 0.3 g/cm³, or 0.3 to 0.9 g/cm³, or 0.3 to 0.8 g/cm³, or 0.3 to 0.7 g/cm³, or 0.3 to 0.6 g/cm³, or 0.3 to 0.5 g/cm³, or 0.3 to 0.4 g/cm³, or 0.3 to 0.9 g/cm³, or 0.4 to 0.8 g/cm³, or 0.4 to 0.7 g/cm³, or 0.4 to 0.6 g/cm³, or 0.4 to 0.5 g/cm³, or 0.5 to 0.9 g/cm³, or 0.5 to 0.8 g/cm³, or 0.5 to 0.7 g/cm³, or 0.5 to 0.6 g/cm³, or 0.6 to 0.9 g/cm³, or 0.6 to 0.8 g/cm³, or 0.6 to 0.7 g/cm³, or 0.7 to 0.9 g/cm³, or 0.7 to 0.8 g/cm³, or 0.8 to 0.9 g/cm³.

In one embodiment or in combination with any of the embodiments mentioned herein, the average foam cell size between 0.05 mm to 1.0 mm, or 0.05 mm to 0.8 mm, or 0.05 mm to 0.6 mm, or 0.08 mm to 0.4 mm, or 0.08 mm to 0.3 mm, or 0.08 mm to 0.2 mm, or 0.08 mm to 0.1 mm, or 0.1 mm to 1.0 mm, or 0.1 mm to 0.8 mm, or 0.1 mm to 0.6 mm, or 0.1 mm to 0.4 mm, or 0.1 mm to 0.3 mm, or 0.1 mm to 0.2 mm, or 0.2 mm to 1.0 mm, or 0.2 mm to 0.8 mm, or 0.2 mm to 0.6 mm, or 0.2 mm to 0.4 mm, or 0.2 mm to 0.3 mm, or 0.2 mm to 0.2 mm, or 0.2 mm to 0.1 mm, or 0.3 mm to 1.0 mm, or 0.3 mm to 0.8 mm, or 0.3 mm to 0.6 mm, or 0.3 mm to 0.4 mm, or 0.4 mm to 1.0 mm, or 0.4 mm to 0.8 mm, or 0.4 mm to 0.6 mm.

In one embodiment or in combination with any of the embodiments mentioned herein, the Rᵣₘₛ surface area roughness is from 0.05 to 500 microns, or 0.05 to 400 microns, or 0.05 to 300 microns, or 0.05 to 200 microns, or 0.05 to 100 microns, or 0.05 to 50 microns, or 0.05 to 25 microns, or 0.05 to 15 microns, or 0.05 to 10 microns, or 0.05 to 5 microns, or 0.1 to 500 microns, or 0.1 to 400 microns, or 0.1 to 300 microns, or 0.1 to 200 microns, or 0.1 to 100 microns, or 0.1 to 50 microns, or 0.1 to 25 microns, or 0.1 to 15 microns, or 0.1 to 10 microns, or 0.1 to 5 microns, or 0.5 to 500 microns, or 0.5 to 400 microns, or 0.5 to 300 microns, or 0.5 to 200 microns, or 0.5 to 100 microns, or 0.5 to 50 microns, or 0.5 to 25 microns, or 0.5 to 15 microns, or 0.5 to 10 microns, or 0.5 to 5 microns, or 1 to 500 microns, or 1 to 400 microns, or 1 to 300 microns, or 1 to 200 microns, or 1 to 100 microns, or 1 to 50 microns, or 1 to 25 microns, or 1 to 15 microns, or 1 to 10 microns, or 1 to 5 microns, or 5 to 500 microns, or 5 to 400 microns, or 5 to 300 microns, or 5 to 200 microns, or 5 to 100 microns, or 5 to 50 microns, or 5 to 25 microns, or 5 to 15 microns, or 5 to 10 microns, or 10 to 500 microns, or 10 to 400 microns, or 10 to 300 microns, or 10 to 200 microns, or 10 to 100 microns, or 10 to 50 microns, or 10 to 25 microns, or 10 to 15 microns, or 15 to 500 microns, or 15 to 400 microns, or 15 to 300 microns, or 15 to 200 microns, or 15 to 100 microns, or 15 to 50 microns, or 15 to 25 microns, or 20 to 500 microns, or 20 to 400 microns, or 20 to 300 microns, or 20 to 200 microns, or 20 to 100 microns, or 20 to 50 microns, or 20 to 25 microns, or 30 to 500 microns, or 30 to 400 microns, or 30 to 300 microns, or 30 to 200 microns, or 30 to 100 microns, or 30 to 50 microns, or 40 to 500 microns, or 40 to 400 microns, or 40 to 300 microns, or 40 to 200 microns, or 40 to 100 microns, or 40 to 50 microns, or 60 to 500 microns, or 60 to 400 microns, or 60 to 300 microns, or 60 to 200 microns, or 60 to 100 microns, or 80 to 500 microns, or 80 to 400 microns, or 80 to 300 microns, or 80 to 200 microns, or 80 to 100 microns, or 100 to 500 microns, or 100 to 400 microns, or 100 to 300 microns, or 100 to 200 microns, or 200 to 500 microns, or 200 to 400 microns, or 200 to 300 microns, or 300 to 500 microns, or 300 to 400 microns, or 400 to 500 microns.

In one embodiment or in combination with any of the embodiments mentioned herein, the density is from 0.04 to 0.3 g/cm³, the average foam cell size is from 0.1 mm to 0.6 mm, and the Rᵣₘₛ surface area roughness is from 1 to 30 microns.

In one embodiment or in combination with any of the embodiments mentioned herein, the foam is in the form of a sheet. In one embodiment or in combination with any of the embodiments mentioned herein, the foam is formed into an article.

In one embodiment or in combination with any of the embodiments mentioned herein, the foam is prepared from a composition comprising: (1) a cellulose acetate having a degree of substitution of acetyl (DS_{Ac}) in the range of from 2.2 to 2.6; (2) 5 to 30 wt % of a plasticizer; (3) 0.1 to 3.0 wt % of a physical nucleating agent; (4) 1.3 to 6.0 wt % of a first physical blowing agent, wherein the proportions of each component of the composition is based on the total weight of the composition.

In one embodiment or in combination with any of the embodiments mentioned herein, the foam is prepared from a composition comprising: (1) a cellulose acetate having a degree of substitution of acetyl (DS_{Ac}) in the range of from 2.2 to 2.6; (2) 5 to 30 wt % of a plasticizer; (3) 0.1 to 3.0 wt % of a physical nucleating agent; (4) 0.1 to 4.5 wt % of a first physical blowing agent which is an unbranched or branched (C₃₋₆)alkane; and (5) 0.1 to 3.0 wt % of a second physical blowing agent chosen from ((C₁₋₃)alkyl)₂O, CO₂, N₂, (C₃₋₇)ketones, (C₁₋₆)alkanol, (C₄₋₆)alkene, or combinations thereof, wherein the proportions of each component of the composition is based on the total weight of the composition.

In one embodiment or in combination with any of the embodiments mentioned herein, the composition further comprises 0.1 to 3 wt % of a second physical blowing agent chosen from ((C₁₋₃)alkyl)₂O, CO₂, N₂, a ((C₁₋₃)alkyl)₂CO, (C₁₋₆)alkanol, (C₄₋₆)alkene, or combinations thereof. In one class of this embodiment the second physical blowing agent is ((C₁₋₃)alkyl)₂O. In one class of this embodiment the second physical blowing agent is CO₂. In one class of this embodiment the second physical blowing agent is N₂. In one class of this embodiment the second physical blowing agent is a ((C₁₋₃)alkyl)₂CO. In one class of this embodiment the second physical blowing agent is (C₁₋₆)alkanol. In one class of this embodiment the second physical blowing agent is an (C₄₋₆)alkene.

In one embodiment or in combination with any of the embodiments mentioned herein, the second physical blowing agent is present from 0.2 to 3 wt %, or 0.2 to 2.5 wt %, or 0.2 to 2 wt %, or 0.2 to 1.5 wt %, or 0.2 to 1 wt %, or 0.2 to 0.5 wt %, or 0.5 to 3 wt %, or 0.5 to 2.5 wt %, or 0.5 to 2 wt %, or 0.5 to 1.5 wt %, or 0.5 to 1 wt %, or 1 to 3 wt %, or 1 to 2.5 wt %, or 1 to 2 wt %, or 1 to 1.5 wt %, or 1.5 to 3 wt %, or 1.5 to 2.5 wt %, or 1.5 to 2 wt %, or 2 to 3 wt %.

The present application discloses a foamable composition comprising: (1) a cellulose acetate having a degree of substitution of acetyl (DS_{Ac}) in the range of from 2.2 to 2.6; (2) 5 to 30 wt % of a plasticizer; (3) 0.1 to 3.0 wt % of a physical nucleating agent; (4) 0.1 to 4.5 wt % of a first physical blowing agent, which is an unbranched or branched (C₃₋₆)alkane; and (5) 0.1 to 3 wt % of a second physical blowing agent chosen from ((C₁₋₃)alkyl)₂O, CO₂, N₂, (C₃₋₇)ketones, (C₁₋₆)alkanol, (C₄₋₆)alkene, or combinations thereof, wherein the proportions of each component of the composition is based on the total weight of the composition. In one class of this embodiment, the first physical blowing agent is present at from 1.3 to 4.5 wt %.

In one embodiment or in combination with any of the embodiments mentioned herein, the unbranched or branched (C₃₋₆)alkane is propane, butane, isobutane, pentane, isopentane, 2,3-dimethylbutane, hexane, 2-methylpentane, or combinations thereof. In one class of this embodiment, the unbranched or branched (C₃₋₆)alkane is propane. In one class of this embodiment, the unbranched or branched (C₃₋₆)alkane is butane. In one class of this embodiment, the unbranched or branched (C₃₋₆)alkane is pentane. In one class of this embodiment, the unbranched or branched (C₃₋₆)alkane is isobutane. In one class of this embodiment, the unbranched or branched (C₃₋₆)alkane is isopentane. In one class of this embodiment, the unbranched or branched (C₃₋₆)alkane is 2,3-dimethylbutane. In one class of this embodiment, the unbranched or branched (C₃₋₆)alkane is hexane. In one class of this embodiment, the unbranched or branched (C₃₋₆)alkane is 2-methylpentane.

In one embodiment or in combination with any of the embodiments mentioned herein, the second physical blowing agent is present from 0.2 to 3 wt %, or 0.2 to 2.5 wt %, or 0.2 to 2 wt %, or 0.2 to 1.5 wt %, or 0.2 to 1 wt %, or 0.2 to 0.5 wt %, or 0.5 to 3 wt %, or 0.5 to 2.5 wt %, or 0.5 to 2 wt %, or 0.5 to 1.5 wt %, or 0.5 to 1 wt %, or 1 to 3 wt %, or 1 to 2.5 wt %, or 1 to 2 wt %, or 1 to 1.5 wt %, or 1.5 to 3 wt %, or 1.5 to 2.5 wt %, or 1.5 to 2 wt %, or 2 to 3 wt %.

In one embodiment or in combination with any of the embodiments mentioned herein, the plasticizer comprises triacetin, triethyl citrate, or a polyethylene glycol having an average weight average molecular weight of from 300 to 1000 Da. In one class of this embodiment, the plasticizer comprises triacetin. In one class of this embodiment, the plasticizer comprises triethyl citrate. In one class of this embodiment, the plasticizer comprises a polyethylene glycol having an average weight average molecular weight of from 300 to 1000 Da. In one subclass of this class the polyethylene glycol has an average weight average molecular weight of from 300 to 500 Da. In one subclass of this class the polyethylene glycol has an average weight average molecular weight of 400 Da.

In one embodiment or in combination with any of the embodiments mentioned herein, the physical nucleating agent comprises a particulate composition with a median particle size of less than or equal to 2 microns. In one class of this embodiment, the physical nucleating agent comprises a particulate composition with a median particle size of from 0.1 to 2 microns. In one class of this embodiment, the physical nucleating agent comprises a particulate composition with a median particle size of from 0.5 to 2 microns. In one class of this embodiment, the physical nucleating agent comprises a particulate composition with a median particle size of from 1 to 2 microns.

In one embodiment or in combination with any of the embodiments mentioned herein, the physical nucleating agent comprises a magnesium silicate, a silicon dioxide, a magnesium oxide or combinations thereof.

In one embodiment or in combination with any of the embodiments mentioned herein, the foam, composition or foamable composition further comprises a biodegradable fiber. In one class of this embodiment, the biodegradable fiber comprises hemp, agave, bagasse, bast, jute, flax, ramie, kenaf, sisal, bamboo, or wood cellulose fibers. In one subclass of this class, the biodegradable fiber comprises bast fibers. In one subclass of this class, the biodegradable fiber comprises agave fibers. In one subclass of this class, the biodegradable fiber comprises bagasse fibers. In one subclass of this class, the biodegradable fiber comprises jute fibers. In one subclass of this class, the biodegradable fiber comprises flax fibers. In one subclass of this class, the biodegradable fiber comprises hemp fibers. In one subclass of this class, the biodegradable fiber comprises ramie fibers. In one subclass of this class, the biodegradable fiber comprises kenaf fibers. In one subclass of this class, the biodegradable fiber comprises bamboo fibers. In one subclass of this class, the biodegradable fiber comprises wood cellulose fibers.

In one embodiment or in combination with any of the embodiments mentioned herein, the foam, composition or foamable composition comprises two or more cellulose acetates having different degrees of substitution of acetyl.

In one embodiment or in combination with any of the embodiments mentioned herein, the foam, composition or foamable composition further comprises a biodegradable polymer that is different than the cellulose acetate. In embodiments, the biodegradable polymer can be chosen from a polyhydroxyalkanoate (PHA), a polylactic acid (PLA), a polycaprolactone (PCL), a polybutylene adipate terephthalate (PBAT), a polyethylene succinate (PES), a polyvinyl acetate (PVA), a polybutylene succinate (PBS) and copolymers (such as polybutylene succinate-co-adipate (PBSA)), a cellulose ester, a cellulose ether, a starch, a protein, derivatives thereof, and combinations thereof. In a class of this embodiment, the biodegradable polymer is chosen from a PHA, a PCL, a PBS, a PBAT, a cellulose ester, a starch, or combinations thereof. The biodegradable polymer (other than cellulose acetate) is present in an amount from 0.1 to less than 50 wt %, or 1 to 40 wt %, or 1 to 30 wt %, or 1 to 25 wt %, or 1 to 20 wt %, based on the total weight of the foam, composition or foamable composition.

In one embodiment or in combination with any of the embodiments mentioned herein, the first physical blowing agent is present at from 1.3 to 1.5 wt %, or 1.3 to 2.0 wt %, or 1.3 to 2.5 wt %, or 1.3 to 3.0 wt %, or 1.3 to 3.5 wt %, or 1.3 to 4.0 wt %, or 1.3 to 4.5 wt %, or 1.3 to 5.0 wt %, or 1.3 to 5.5 wt %, or 1.5 to 3.0 wt %, or 1.5 to 4.0 wt %, or 1.5 to 5.0 wt %, or 1.5 to 6.0 wt %, or 2.0 to 3.0 wt %, or 2.0 to 4.0 wt %, or 2.0 to 5.0 wt %, or 2.0 to 6.0 wt %, or 2.5 to 3.0 wt %, or 2.5 to 4.0 wt %, or 2.5 to 5.0 wt %, or 2.5 to 6.0 wt %, or 3.0 to 4.0 wt %, or 3.0 to 5.0 wt %, or 3.0 to 6.0 wt %.

In one embodiment or in combination with any of the embodiments mentioned herein, the physical nucleating agent is present at from 0.1 to 2.5 wt %, or 0.1 to 2.0 wt %, or 0.1 to 1.5 wt %, or 0.1 to 1.0 wt %, or 0.1 to 0.5 wt %, or 0.2 to 3.0 wt %, or 0.2 to 2.5 wt %, or 0.2 to 2.0 wt %, or 0.2 to 1.5 wt %, or 0.2 to 1.0 wt %, or 0.2 to 0.5 wt %, or 0.5 to 2.5 wt %, or 0.5 to 2.0 wt %, or 0.5 to 1.5 wt %, 0.5 to 1.0 wt %, or 1.0 to 6.0 wt %, or 1.0 to 5.5 wt %, or 1.0 to 5.0 wt %, 1.0 to 4.5 wt %, or 1.0 to 4.0 wt %, or 1.0 to 3.5 wt %, or 1.0 to 3.0 wt %, or 1.0 to 2.5 wt %, or 1.0 to 2.0 wt %, or 1.0 to 1.5 wt %, or 1.5 to 6.0 wt %, or 1.5 to 5.5 wt %, or 1.5 to 5.0 wt %, or 1.5 to 4.5 wt %, or 1.5 to 4.0 wt %, or 1.5 to 3.5 wt %, or 1.5 to 3.0 wt %, or 1.5 to 2.5 wt %, or 1.5 to 2.0 wt %, or 2.0 to 6.0 wt %, or 2.0 to 5.5 wt %, or 2.0 to 5.0 wt %, or 2.0 to 4.5 wt %, or 2.0 to 4.0 wt %, or 2.0 to 3.5 wt %, or 2.0 to 3.0 wt %, or 2.0 to 2.5 wt %, or 2.5 to 6.0 wt %, or 2.5 to 5.5 wt %, or 2.5 to 5.0 wt %, or 2.5 to 4.5 wt %, or 2.5 to 4.0 wt %, or 2.5 to 3.5 wt %, or 2.5 to 3.0 wt %, or 3.0 to 6.0 wt %, or 3.0 to 5.5 wt %, or 3.0 to 5.0 wt %, or 3.0 to 4.5 wt %, or 3.0 to 4.0 wt %, or 3.0 to 3.5 wt %, or 3.5 to 6.0 wt %, or 3.5 to 5.5 wt %, or 3.5 to 5.0 wt %, or 3.5 to 4.5 wt %, or 3.5 to 4.0 wt %, or 4.0 to 6.0 wt %, or 4.0 to 5.5 wt %, or 4.0 to 5.0 wt %, or 4.0 to 4.5 wt %, or 4.5 to 6.0 wt %, or 4.5 to 5.5 wt %, or 4.5 to 5.0 wt %.

In one embodiment or in combination with any of the embodiments mentioned herein, the plasticizer is present at from 5 to 25 wt %, or 5 to 20 wt %, or 5 to 15 wt % or 5 to 10 wt %, or 6 to 30 wt %, or 6 to 25 wt %, or 6 to 20 wt %, or 6 to 15 wt %, or 6 to 10 wt %, or 7 to 30 wt %, or 7 to 25 wt %, or 7 to 20 wt %, or 7 to 15 wt %, or 7 to 10 wt %, or 8 to 30 wt %, or 8 to 25 wt %, or 8 to 20 wt %, or 8 to 15 wt %, or 8 to 10 wt %, or 9 to 30 wt %, or 9 to 25 wt %, or 9 to 20 wt %, or 8 to 15 wt %, or 9 to 30 wt %, or 9 to 25 wt %, or 9 to 20 wt %, or 9 to 15 wt %, or 10 to 30 wt %, or 10 to 25 wt %, or 10 to 20 wt %, or 10 to 15 wt %, or 15 to 30 wt %, or 15 to 25 wt %, or 15 to 20 wt %, or 20 to 30 wt %, or 20 to 25 wt %.

The present application discloses an article prepared from any of the mentioned biodegradable cellulose acetate foams or compositions disclosed herein.

To be considered “compostable,” a material must meet the following four criteria: (1) the material should pass biodegradation requirement in a test under controlled composting conditions at elevated temperature (58° C.) according to ISO 14855-1 (2012) which correspond to an absolute 90% biodegradation or a relative 90% to a control polymer, (2) the material tested under aerobic composting condition according to ISO16929 (2013) must reach a 90% disintegration; (3) the test material must fulfill all the requirements on volatile solids, heavy metals and fluorine as stipulated by ASTM D6400 (2012), EN 13432 (2000) and ISO 17088 (2012); and (4) the material should not cause negative on plant growth. As used herein, the term “biodegradable” generally refers to the biological conversion and consumption of organic molecules. Biodegradability is an intrinsic property of the material itself, and the material can exhibit different degrees of biodegradability, depending on the specific conditions to which it is exposed. The term “disintegrable” refers to the tendency of a material to physically decompose into smaller fragments when exposed to certain conditions. Disintegration depends both on the material itself, as well as the physical size and configuration of the article being tested. Ecotoxicity measures the impact of the material on plant life, and the heavy metal content of the material is determined according to the procedures laid out in the standard test method.

To be considered “biodegradable,” under home composting conditions according to the French norm NF T 51-800 and the Australian standard AS 5810, a material must exhibit a biodegradation of at least 90 percent in total (e.g., as compared to the initial sample), or a biodegradation of at least 90 percent of the maximum degradation of a suitable reference material after a plateau has been reached for both the reference and test item. The maximum test duration for biodegradation under home compositing conditions is 1 year.

To be considered “biodegradable,” under industrial composting conditions according to ASTM D6400 and ISO 17088, at least 90 percent of the organic carbon in the whole item (or for each constituent present in an amount of more than 1% by dry mass) must be converted to carbon dioxide by the end of the test period when compared to the control or in absolute. According to European standard ED 13432 (2000), a material must exhibit a biodegradation of at least 90 percent in total, or a biodegradation of at least 90 percent of the maximum degradation of a suitable reference material after a plateau has been reached for both the reference and test item. The maximum test duration for biodegradability under industrial compositing conditions is 180 days.

In order to be considered “biodegradable,” under soil composting conditions according the OK biodegradable SOIL conformity mark of Vingotte and the DIN GeprOft Biodegradable in soil certification scheme of DIN CERTCO, a material must exhibit a biodegradation of at least 90 percent in total (e.g., as compared to the initial sample), or a biodegradation of at least 90 percent of the maximum degradation of a suitable reference material after a plateau has been reached for both the reference and test item. The maximum test duration for biodegradability under soil compositing conditions is 2 years.

In one embodiment or in combination with any of the embodiments mentioned herein, the biodegradable cellulose acetate foam or article is industrial compostable or home compostable. In one subclass of this class, the foam or article is industrial compostable. In one sub-subclass of this subclass, the foam or article has a thickness that is less than 12 mm. In one sub-subclass of this subclass, the foam or article has a thickness that is less than 10 mm. In one sub-subclass of this subclass, the foam or article has a thickness that is less than 8 mm. In one sub-subclass of this subclass, the foam or article has a thickness that is less than 7 mm. In one sub-subclass of this subclass, the foam or article has a thickness that is less than 6 mm. In one sub-subclass of this subclass, the foam or article has a thickness that is less than 3 mm. In one sub-subclass of this subclass, the article has a thickness that is less than 1.1 mm. In one subclass of this class, the foam or article is home compostable. In one sub-subclass of this subclass, the foam or article has a thickness that is less than 6 mm. In one sub-subclass of this subclass, the foam or article has a thickness that is less than 3 mm. In one sub-subclass of this subclass, the foam or article has a thickness that is less than 1.1 mm. In one sub-subclass of this subclass, the foam or article has a thickness that is less than 0.8 mm. In one sub-subclass of this subclass, the foam or article has a thickness that is less than 0.6 mm. In one sub-subclass of this subclass, the foam or article has a thickness that is less than 0.4 mm.

In one embodiment or in combination with any of the embodiments mentioned herein, the thickness of the foam or article is less than 3 mm.

In one embodiment or in combination with any of the embodiments mentioned herein, the foam or article exhibits greater than 90% disintegration after 12 weeks according to the disintegration test protocol for films, as described in the specification.

The compositions used to prepare the biodegradable cellulose acetate foams can comprise other additives such as fillers, stabilizers, odor modifiers, waxes, compatibilizers, biodegradation promoters, dyes, pigments, colorants, lubricants, anti-oxidants, viscosity modifiers, antifungal agents, heat stabilizers, antibacterial agents, softening agents, mold release agents, and combinations thereof. It should be noted that the same type of compounds or materials can be identified for or included in multiple categories of components in the cellulose acetate compositions. For example, polyethylene glycol (PEG) could function as a plasticizer or as an additive that does not function as a plasticizer, such as a hydrophilic polymer or biodegradation promotor, e.g., where a lower molecular weight PEG has a plasticizing effect and a higher molecular weight PEG functions as a hydrophilic polymer but without plasticizing effect.

In one embodiment or in combination with any other embodiment, the biodegradable cellulose acetate foam exhibits a heat deflection temperature of greater than 100° C. as measured at 0.45 MPa at 2% elongation with a 1 Hz frequency using a DMA. In one embodiment or in combination with any other embodiment, the biodegradable cellulose acetate foam exhibits a heat deflection temperature of greater than 102° C. as measured at 0.45 MPa at 2% elongation with a 1 Hz frequency using a DMA. In one embodiment or in combination with any other embodiment, the biodegradable cellulose acetate foam exhibits a heat deflection temperature of greater than 104° C. as measured at 0.45 MPa at 2% elongation with a 1 Hz frequency using a DMA. In one embodiment or in combination with any other embodiment, the biodegradable cellulose acetate foam exhibits a heat deflection temperature of greater than 106° C. as measured at 0.45 MPa at 2% elongation with a 1 Hz frequency using a DMA. In one embodiment or in combination with any other embodiment, the biodegradable cellulose acetate foam exhibits a heat deflection temperature of greater than 110° C. as measured at 0.45 MPa at 2% elongation with a 1 Hz frequency using a DMA. In one embodiment or in combination with any other embodiment, the biodegradable cellulose acetate foam exhibits a heat deflection temperature of greater than 115° C. as measured at 0.45 MPa at 2% elongation with a 1 Hz frequency using a DMA.

In one embodiment or in combination with any other embodiment mentioned herein, the foam, composition or foamable composition further comprises a photodegradation catalyst. In one class of this embodiment, the photodegradation catalyst is a titanium dioxide, or an iron oxide. In one subclass of this class, the photodegradation catalyst is a titanium dioxide. In one subclass of this class, the photodegradation catalyst is an iron oxide.

In one embodiment or in combination with any other embodiment mentioned herein, the foam, composition, or foamable composition further comprises a pigment. In one class of this embodiment, the pigment is a titanium dioxide, a carbon black, or an iron oxide. In one subclass of this class, the pigment is a titanium dioxide. In one subclass of this class, the pigment is a carbon black. In one subclass of this class, the pigment is an iron oxide.

### CLAIMS NOT LIMITED TO DISCLOSED EMBODIMENTS

The preferred forms of the invention described above are to be used as illustration only and should not be used in a limiting sense to interpret the scope of the present invention. Modifications to the exemplary embodiments, set forth above, could be readily made by those skilled in the art without departing from the spirit of the present invention.

The inventors hereby state their intent to rely on the Doctrine of Equivalents to determine and assess the reasonably fair scope of the present invention as it pertains to any apparatus not materially departing from but outside the literal scope of the invention as set forth in the following claims.

In one embodiment or in combination with any other embodiment, the foam or article exhibits greater than 30% disintegration after 12 weeks according to Disintegration Test Protocol, as described in the specification or in the alternative according to ISO 16929 (2013). In one embodiment or in combination with any other embodiment, the foam or article exhibits greater than 50% disintegration after 12 weeks according to Disintegration Test Protocol, as described in the specification or in the alternative according to ISO 16929 (2013). In one embodiment or in combination with any other embodiment, the foam or article exhibits greater than 70% disintegration after 12 weeks according to Disintegration Test Protocol, as described in the specification or in the alternative according to ISO 16929 (2013). In one embodiment or in combination with any other embodiment, the foam or article exhibits greater than 80% disintegration after 12 weeks according to Disintegration Test Protocol, as described in the specification or in the alternative according to ISO 16929 (2013). In one embodiment or in combination with any other embodiment, the foam or article exhibits greater than 90% disintegration after 12 weeks according to Disintegration Test Protocol, as described in the specification or in the alternative according to ISO 16929 (2013). In one embodiment or in combination with any other embodiment, the foam or article exhibits greater than 95% disintegration after 12 weeks according to Disintegration Test Protocol, as described in the specification or in the alternative according to ISO 16929 (2013).

### EXAMPLES

### Abbreviations

PBA is physical blowing agent; PNA is physical nucleating agent; wt % is weight percent; Ex is example; SR is Rᵣₘₛ surface area roughness;

Table 1 provides extruded foam sheets along with their densities made from triacetin (20 wt/o) plasticized Eastman CA 398-30 (DSAc=2.52, melting point 230-250° C., Tg-189° C.), talc and C₀₂ or pentane. The extruded foam sheets were made using a tandem extruder setup. The physical blowing agent and talc was mixed in the twin screw extruder (ZE 30) followed by transferring the melt to the single screw extruder (KE 60). An annular die was used to extrude the foam sheet tube before stretching and cutting the sheet open over a calibrator cylinder.

### Surface Roughness

The surface roughness was measured on the extruded foam sheets using a Bruker ContourGT optical profilometer. Surface roughness was measured at 3 spots on a side of the sheet. A 0.55× magnification objective was used and the base roughness (RMS) value was obtained.

### Density

Density was measured by Mettler-Toledo density kit fitted to an analytical balance. Five circular sections were removed from each sheet with a 22 mm punch. Each replicate was weighed first in air, then submerged in deionized water. Water was changed daily, with temperature checked hourly while in use.

### Cell Size

Cell size was measured using a scanning electron microscope (SEM). The sheet cross-section was prepared for imaging using a microtome, with cross-section imaged along the machine direction and transverse direction of each extruded sheet. The SEM images were analyzed via ImageJ software to measure 5 randomly selected cells in each image. The cell size values reported is an average measurement for >10 values measured for each sample.

TABLE 1

| | | | | | | | Cell |
|---|---|---|---|---|---|---|---|
| Ex | | | Triacetin | Talc | Density | SR | Size |
| # | CA | PBA (wt %) | (wt %) | (wt %) | (g/cm³) | (μm) | (μm) |
| 1 | CA-398-30 | CO₂ (1) | 20 | 0.75 | 0.161 | 15 | 486 |
| 2 | CA398-30 | CO₂ (1.2) | 20 | 0.75 | 0.159 | 24 | 513 |
| 3 | CA-398-30 | CO₂ (1.2) | 20 | 0.75 | 0.157 | 16 | 508 |
| 4 | CA-398-30 | CO₂ (1.1) | 20 | 0.75 | 0.197 | 20 | 363 |
| 5 | CA-398-30 | CO₂ (1.1) | 20 | 0.75 | 0.151 | 17 | 618 |
| 6 | CA-398-30 | CO₂ (1.1) | 20 | 0.75 | 0.144 | 22 | 510 |
| 7 | CA-398-30 | CO₂ (1.1) | 20 | 0.75 | 0.172 | 18 | 630 |
| 8 | CA-398-30 | CO₂ (1.1) | 20 | 0.75 | 0.138 | 18 | 637 |
| 9 | CA-398-30 | CO₂ (1.2) | 20 | 0.75 | 0.133 | 20 | 386 |
| 10 | CA-398-30 | CO₂ (1.2) | 20 | 0.75 | 0.141 | 19 | 426 |
| 11 | CA-398-30 | CO₂ (1.2) | 20 | 0.75 | 0.143 | 20 | 363 |
| 12 | CA-394-60S | CO₂ (1.1) | 20 | 0.75 | 0.131 | 15.6 | 386 |
| 13 | CA-394-60S | CO₂ (1) | 20 | 0.75 | 0.187 | 15.5 | 414 |
| 14 | CA-394-60S | CO₂ (1.5) | 20 | 0.75 | 0.137 | 23.6 | 363 |
| 15 | CA-398-30 | pentane (1.05) | 20 | 0.75 | 0.622 | — | — |
| 16 | CA-398-30 | pentane (1.97) | 20 | 0.75 | 0.453 | — | — |
| 17 | CA-398-30 | pentane (2.35) | 20 | 0.75 | 0.177 | — | — |
| 18 | CA-398-30 | pentane (3.6) | 20 | 0.75 | 0.09 | — | — |
| 19 | CA-394-60S | Pentane (3) | 20 | 0.75 | 0.111 | 10.8 | 474 |
| 20 | CA-394-60S | Pentane (3) | 20 | 0.75 | 0.118 | 6.1 | 314 |
| 21 | CA-394-60S | Pentane (3) | 20 | 0.75 | 0.105 | 6.7 | 318 |
| 22 | CA-394-60S | Isopentane (2.98) | 20 | 0.75 | 0.1 | 10.4 | 156 |
| 23 | CA-394-60S | Isobutane:EtOH:CO₂ | 20 | 0.75 | 0.077 | 7.9 | 252 |
| | | [42:42:18] (2.4) | | | | | |
| 24 | CA-394-60S | Pentane:CO₂ | 20 | 0.75 | 0.11 | 10.5 | 282 |
| | | [1.5:1.5] (3) | | | | | |

1. A biodegradable cellulose acetate foam, wherein the foam has a density of from 0.04 to 0.3 g/cm³, an average foam cell size from 0.1 mm to 0.6 mm, and wherein the Rᵣₘₛ surface area roughness is from 1 to 30 microns.

2. (canceled)

3. The biodegradable cellulose acetate foam of claim 1, wherein the foam further comprises 5 to 30 wt % of a plasticizer, and 0.1 to 3.0 wt % of a physical nucleating agent, based on the total weight of the foam, wherein the plasticizer comprises triacetin, triethyl citrate, or polyethylene glycol having an average weight average molecular weight of from 300 to 1000 Da, wherein the physical nucleating agent comprises a particulate composition with a median particle size of less than or equal to 2 microns, and wherein the physical nucleating agent comprises a magnesium silicate, a silicon dioxide, a magnesium oxide or combinations thereof.

4. The biodegradable cellulose acetate foam of claim 3, wherein the foam is a sheet.

5. A foamable composition comprising:
(1) a cellulose acetate having a degree of substitution of acetyl (DS_{Ac}) in the range of from 2.2 to 2.6;
(2) 5 to 30 wt % of a plasticizer;
(3) 0.1 to 3.0 wt % of a physical nucleating agent;
(4) 0.1 to 4.5 wt % of a first physical blowing agent which is an unbranched or branched (C₃₋₆)alkane; and
(5) 0.1 to 3.0 wt % of a second physical blowing agent chosen from ((C₁₋₃)alkyl)₂O, CO₂, N₂, (C₃₋₇)ketones, (C₁₋₆)alkanol, (C₄₋₆)alkene, or combinations thereof,
wherein the proportions of each component of the composition is based on the total weight of the composition.

6. The foamable composition of claim 5, wherein the unbranched or branched (C₃₋₆)alkane is propane, butane, isobutane, pentane, isopentane, 2,3-dimethylbutane, hexane, 2-methylpentane, or combinations thereof.

7. The foamable composition of claim 3, wherein the plasticizer comprises triacetin.

8. (canceled)

9. The foamable composition of claim 5, wherein the physical nucleating agent comprises a particulate composition with a median particle size of less than or equal to 2 microns.

10. The foamable composition of claim 9, wherein the physical nucleating agent comprises a magnesium silicate, a silicon dioxide, a magnesium oxide or combinations thereof.

11. The foamable composition of claim 5, wherein the foamable composition further comprises a biodegradable fiber, wherein the biodegradable fiber comprises hemp, agave, bagasse, bast, jute, flax, ramie, kenaf, sisal, bamboo, or wood cellulose fibers.

12. (canceled)

13. The foamable composition of claim 5, wherein foamable composition comprises two or more cellulose acetates having different degrees of substitution of acetyl.

14. The foamable composition of claim 5, wherein the foamable composition further comprises a biodegradable polymer that is different than the cellulose acetate.

15. An article prepared from the foamable composition of claim 5.

16. The biodegradable cellulose acetate foam of claim 1, wherein the biodegradable cellulose acetate foam is industrial compostable or home compostable.

17. The biodegradable cellulose acetate foam of claim 1, wherein the thickness of the foam is less than 8 mm.

18. The biodegradable cellulose acetate foam of claim 1, wherein the foam further comprises a biodegradable polymer that is different than the cellulose acetate,
wherein the biodegradable polymer is chosen from a polyhydroxyalkanoate (“PHA”), a polylactic acid (“PLA”), a polycaprolactone (“PCL”), a polybutylene adipate terephthalate (“PBAT”), a cellulose ester, a cellulose ether, a starch, a protein, and combinations thereof, and
wherein the biodegradable polymer is present in the amount of from 0.1 to less than 50 wt %, based on the total weight of the foamable composition.

19-20. (canceled)

21. The foamable composition of claim 5, wherein the foamable composition further comprises 5 to 30 wt % of a plasticizer, and 0.1 to 3.0 wt % of a physical nucleating agent, based on the total weight of the foam,
wherein the plasticizer comprises triacetin, triethyl citrate, or polyethylene glycol having an average weight average molecular weight of from 300 to 1000 Da,
wherein the physical nucleating agent comprises a particulate composition with a median particle size of less than or equal to 2 microns, and
wherein the physical nucleating agent comprises a magnesium silicate, a silicon dioxide, a magnesium oxide or combinations thereof.

22. The article of claim 15, wherein the article is industrial compostable or home compostable.

23. The biodegradable cellulose acetate foam of claim 1, wherein the foam further comprises a biodegradable fiber, wherein the biodegradable fiber comprises hemp, agave, bagasse, bast, jute, flax, ramie, kenaf, sisal, bamboo, or wood cellulose fibers.

24. The biodegradable cellulose acetate foam of claim 1, wherein the foam comprises two or more cellulose acetates having different degrees of substitution of acetyl.

25. The biodegradable cellulose acetate foam of claim 1, wherein the foam further comprises a biodegradable polymer that is different than the cellulose acetate,
wherein the biodegradable polymer is chosen from a polyhydroxyalkanoate (“PHA”), a polylactic acid (“PLA”), a polycaprolactone (“PCL”), a polybutylene adipate terephthalate (“PBAT”), a cellulose ester, a cellulose ether, a starch, a protein, and combinations thereof,
wherein the biodegradable polymer is present in the amount of from 0.1 to less than 50 wt %, based on the total weight of the foam.
